(19) United States
(12) Patent Application Publication
(10) Pub. No.: US 2004/0088647 A1
(43) Pub. Date: May 6, 2004

(54) Web-based XML document processing system

(76) Inventors: Adrian S. Miller, Redmond, WA (US); James P. Lawyer, Pompey, NY (US)

Correspondence Address: HOFFMAN WARNICK & D'ALESSANDRO, LLC, 3 E-COMM SQUARE, ALBANY, NY, 12207

(21) Appl. No.: 10/288,878

(22) Filed: Nov. 6, 2002

(51) Int. Cl. G06F 17/00

(52) U.S. Cl. 715/500; 715/513

(57) ABSTRACT

A system and method for processing extensible markup language (XML) documents over the World Wide Web via a remote server. In one aspect, the invention provides: a workspace management system for creating unique workspaces for each of a plurality of organizations; an XML editing system having a template editing system for editing XML templates, a content editing system for editing XML content, and a document collaboration system for controlling access to XML documents; a database for remotely storing XML documents for the plurality of organizations; and an application server for serving the workspace and XML editing system to clients via the World Wide Web. Also included is a system for publishing the XML documents stored in the database to a company's website or for publishing in a non-HTML format.

### BACKGROUND OF THE INVENTION

1. Technical Field

The present invention relates generally to document editing systems, and more specifically relates to a multi-user XML (extensible mark-up language) document processing system that can be accessed and run via the World Wide Web.

2. Related Art

One of the ongoing challenges associated with the World Wide Web (“Web”) is the ability to provide and manage web page content. Because web pages typically exist in hypertext mark-up language (HTML), the content is not directly compatible with most user-friendly text based editors. Thus, it is not a simple operation to modify or add content to a web page, particularly in cases where separation of content from presentation is desirable. In a typical environment, content contributors send one or more documents in a proprietary word processing file or some other “non-Web-ready” format to the Webmaster, who then must convert the documents to HTML before they can be uploaded to a website.

One proposed solution has been to implement an extensible mark-up language (XML) based website, rather than standard HTML. Content stored in an XML format can be readily transformed into many different formats, including HTML. XML is useful because, unlike HTML, it separates content from presentation. Thus, for example, XML can be utilized to create web page “templates” (i.e., presentation) that can incorporate textual information (i.e., content), which can be readily modified with an XML authoring tool. An XML template thus allows for the creation of a specific type of XML document, as defined by an XML Schema (XSD) or Document Type Definition (DTD). Templates can be designed for any web page, including: job postings, help topics, product descriptions, etc. An authoring tool can also be provided to edit relevant portions of the template. By utilizing such a system, the time-consuming step of converting documents to HTML is eliminated.

Unfortunately, existing XML authoring tools have several drawbacks. First, most existing XML tools target technical authors and are often too difficult for regular content editors (e.g., business authors) to use. In particular, a fair amount of expertise is required to create XML templates, such as that of a Webmaster, which most content editors lack. Accordingly, today's stand-alone XML tools must be shared by skilled and unskilled users. As a result, most business authors continue to use some other tool (e.g., Microsoft WORD™) to write their content, thereby requiring the webmaster to re-author such documents in an XML editor.

Secondly, a typical company website may receive content contributions from numerous authors, residing at different physical locations. In such a case, the company must purchase, install and maintain numerous copies of an XML editor for each potential user. Moreover, because multiple people may want to edit the same document, many different versions of a document may exist in different physical locations, thereby causing significant version control issues.

Finally, even after an XML document is successfully created, it is not ready to be “published” to the organizations website. Rather, the document must first be transformed against an extensible stylesheet (XSLT), that is specific to the organization's website. Accordingly, further expertise is typically required to publish an XML document to a website.

Accordingly, a need exists for an XML authoring system that provides an easy to use interface that can manage content in a central location with a lower cost of operation. In addition, a simplified system for publishing XML documents to a website is required.

### SUMMARY OF THE INVENTION

The present invention addresses the above-mentioned problems, as well as others, by providing an XML document processing system that is delivered via the web in a multi-user environment thereby enabling efficient workflow of XML document editing. In a first aspect, the invention provides a system for processing extensible markup language (XML) documents over the World Wide Web via a remote server, wherein the remote server comprises: a workspace management system for creating unique workspaces for each of a plurality of organizations, wherein the workspace management system includes a document collaboration system for controlling access to XML documents; an XML editing system for editing XML documents, comprising a template editing system for editing XML templates and a content editing system for editing XML content; a database for remotely storing XML documents for the plurality of organizations; and an application server for serving workspaces and the XML editing system to clients via the World Wide Web.

In a second aspect, the invention provides a web-based extensible markup language (XML) document processing system, comprising: a system for remotely accessing a shared workspace from a web browser; a system for remotely accessing and storing XML templates and XML documents from within the shared workspace; a system for remotely editing XML content from within a browser window; and a system for controlling access to XML documents from within the shared workspace.

In a third aspect, the invention provides a method of creating XML documents in a web-based shared workspace environment, comprising: providing a server having: a workspace management system for creating a workspace for a plurality of users within an organization, an XML template editing system, an XML content editing system, and a database for remotely storing XML documents; assigning permission levels to each of the plurality of users, wherein the permission levels include template editor and content editor; logging a first user having template editor permission into the workspace via a first browser; serving the XML template editing system to the first user and allowing the first user to create an XML template in the first browser; storing the created XML template in the database such that it is available via the workspace; logging a second user having content editor permission into the workspace via a second browser; serving the content editing system in the second browser to the second user and allowing the second user to create an XML document using the XML template; and storing the XML document in the database such that the XML document is available via the workspace.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a web server having an XML editing system and workspace management system in accordance with the present invention.

FIG. 2 depicts a workspace in accordance with the present invention.

FIG. 3 depicts a GUI of a workspace in accordance with the present invention.

FIG. 4 depicts an exemplary workflow in accordance with the present invention.

FIG. 5 depicts a content editing window in accordance with the present invention.

FIG. 6 depicts an XML document viewer in accordance with the present invention.

FIG. 7 depicts a first embodiment of an XML publishing system in accordance with the present invention.

FIG. 8 depicts a second embodiment of an XML publishing system in accordance with the present invention.

### DETAILED DESCRIPTION OF THE INVENTION

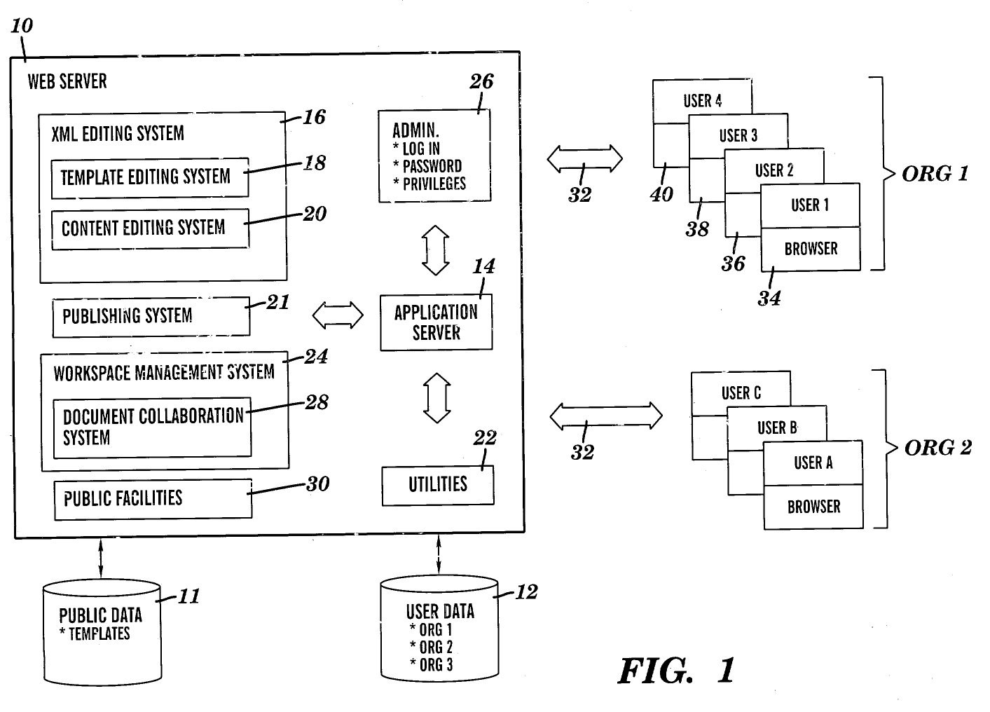

Referring now to the drawings, FIG. 1 depicts a web-based XML document processing system embodied in a web server 10. Users associated with an organization (e.g., ORG 1 and ORG 2) can access the server 10 via a network 32, such as the World Wide Web, or other similar Internet or intranet based architecture. As described below, users can process, i.e., create, edit, review, search, publish, etc., XML documents remotely via web server 10. Accordingly, web server 10 provides a remote, multi-user workflow environment, in which XML document processing can be handled in an efficient manner.

Web server 10 can be implemented on any type of known server system capable of delivering data over a network 32, e.g., an advanced mid-range multiprocessor-based server utilizing standard operating system software, designed to drive the operation of the particular hardware and which is compatible with other system components and I/O controllers.

Communications over network 32 can be implemented using any method or combination of methods, including, wireless, satellite, Ethernet, fiber optic, serial, parallel, etc. Network 32 generally represents the World Wide Web, but can comprise any type of network, including, a private network, such as a one-to-one connection, an office-wide or company-wide network, a virtual private network (VPN), a public network, such as a local area network (LAN), a wide area network (WAN), a global network, the Internet, or a combination of public and private networks.

Server 10 can be implemented by a single processing computing system, multiple processing units capable of parallel operation, or be distributed across one or more processing units in one or more locations. I/O interfaces may be included and comprise any system for exchanging information with one or more I/O devices, including an I/O port (serial, parallel, Ethernet, keyboard, mouse, etc.), a universal serial bus (USB) port, expansion bus, integrated drive electronics (IDE), etc. I/O devices may comprise any known type of input/output device capable of communicating with I/O interface with or without additional devices (i.e., expansion cards), including a network system, a modem, speakers, a monitor (cathode-ray tube (CRT), liquid-crystal display (LCD), etc.), handheld device, keyboard, mouse, voice recognition system, speech output system, scanner, printer, facsimile, pager, storage devices, etc.

Databases 11, 12 may provide storage for information necessary to carry out the present invention as described in more detail below. As such, databases 11, 12 may include one or more storage devices, such as a magnetic disk drive or an optical disk drive. Further, databases 11, 12 can include data distributed across, for example, a LAN, WAN or a storage area network (SAN) (not shown).

It is understood that each user accesses web server 10 with a client program (i.e., browser) that may typically reside on a user device containing known computing components (e.g., CPU, memory, etc.). Such components have not been separately depicted and described for brevity purposes. Such user devices can comprise any type of device capable of accepting input, providing output, and communicating with another device. For example, a user device can be a personal computer, a mobile phone, a handheld computer, a personal digital assistant, a portable (e.g., laptop) computer, a mainframe computer, etc.

Web server 10 includes an XML editing system 16, a workspace management system 24, a publishing system 21, an administration system 26, various public facilities 30, utilities 22, an application server 14 and one or more databases 11, 12. XML editing system 16 includes a template editing system 18 for creating, copying and editing XML templates, and a content editing system 20 for creating and editing XML content associated with an XML template. For the purposes of this description, the combination of an XML template and XML content forms an XML document.

Workspace management system 24 provides unique workspaces for defined sets of members. In a typical scenario, a workspace will be created for an organization (e.g., ORG 1), and will be accessible by a group of users (User 1, User 2, User 3 and User 4). However, it should be understood that an organization might have multiple workspaces, each with the same or different sets of users. A workspace may also be made up of users from many different organizations, e.g., an entity and its customers could share a workspace. Thus, the relationship between workspaces and organizations may be many-to-many, one-to-many, or many-to-one.

Workspace management system 24 comprises a document collaboration system 28 that controls the processing of XML templates, content and documents within a workspace. In particular, document collaboration system 28 recognizes different permissions or privilege levels for different users, thereby restricting access to appropriate users for different aspects of the XML document creation process. For example, a user could be granted administrative, template editing, content editing, review, and/or publish rights within a workspace. Thus, for instance, XML template editing can be limited to only those users having the necessary technical capability.

In addition to recognizing privilege levels, document collaboration system 28 includes a check-in/check-out mechanism that requires users to first checkout an XML document before editing it. Thus, only one user can edit a document at a time, therefore avoiding multiple versions of the same XML document existing within an organization. Moreover, XML documents must be checked back into the workspace, thereby leaving an audit trail of those users who edited the document.

Administration system 26 manages access to web server 10 via a log in/password system, associates a user with a workspace, and determines privileges for the each user. Administration system 26 also allows users to set preferences, create new workspaces, etc. Utilities 22 provide various ancillary functions related to the processing of XML documents in a multi-user workspace environment. Examples include the ability to email other users within an organization, search XML documents, generate feedback, etc. Public facilities 30 provide various features that are available to all users (i.e., the entire XML community) that access web server 10. For example, users may wish to share XML templates and other XML content, discuss features via a news group, provide feedback, etc.

Databases 11, 12 are comprised of public data 11 and user data 12. Public data 11 may comprise public templates that are available to any organization and/or workspace. User data 12 comprises XML templates, content and documents for each organization. By storing user data 12 remotely from the users, the organization need not concern itself with managing and storing such data.

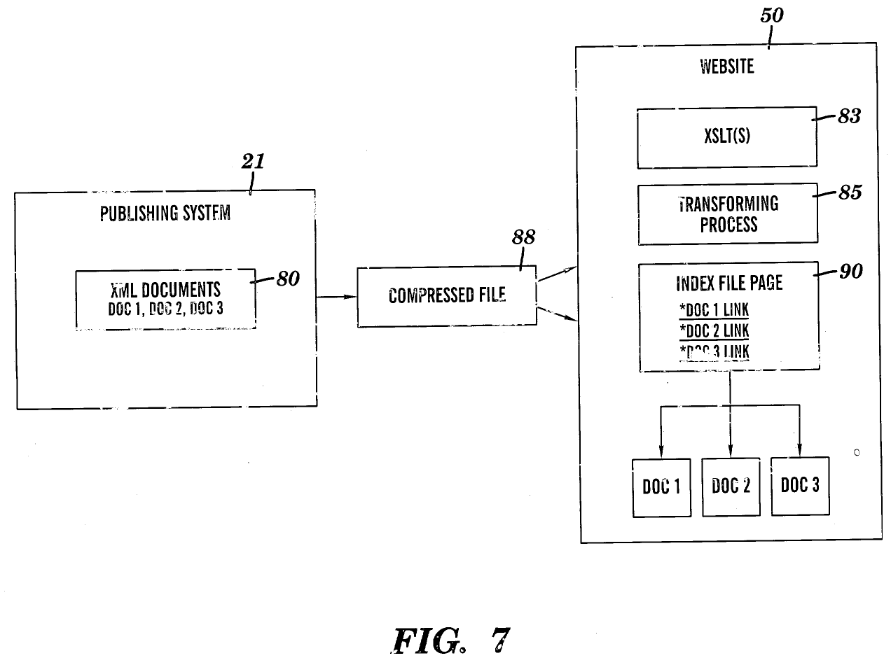

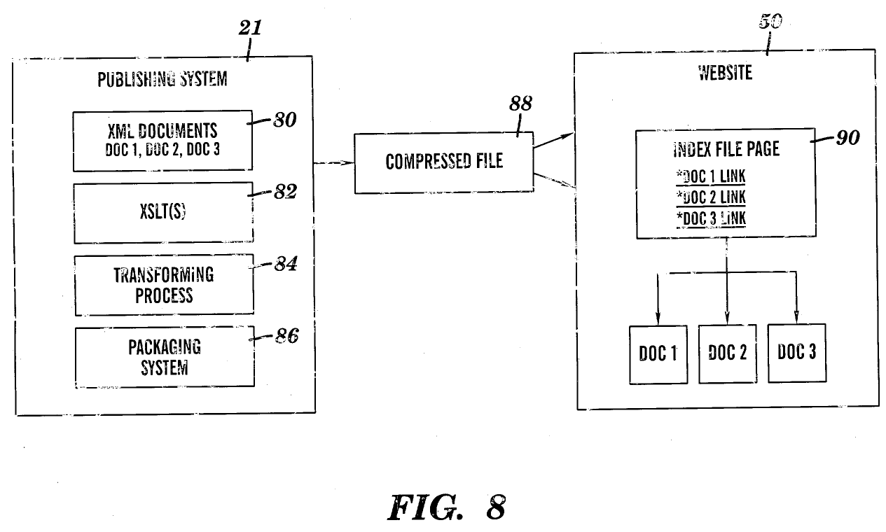

Publishing system 21 provides an easy to use mechanism for publishing created XML documents to an organization's website or for non-web-based consumption, e.g., publishing manuals, printing, generating PDF files, etc. Accordingly, while the exemplary embodiments are generally described herein with reference to creating HTML content for websites, it should be understood that the invention could also be used to create non-HTML content. Details of publishing system are described below with reference to FIGS. 7 and 8.

Each of the above-described systems is served to users (e.g., User 1-4) via application server 14. Applications may be delivered using any known technology, e.g., ASP, ASP.NET, Java, etc. Users access the applications via a browser 34, 36, 38, 40. Because all of applications and data for the XML document processing system are located remotely, users can access organizational or workspace specific documents from any browser that can access the web.

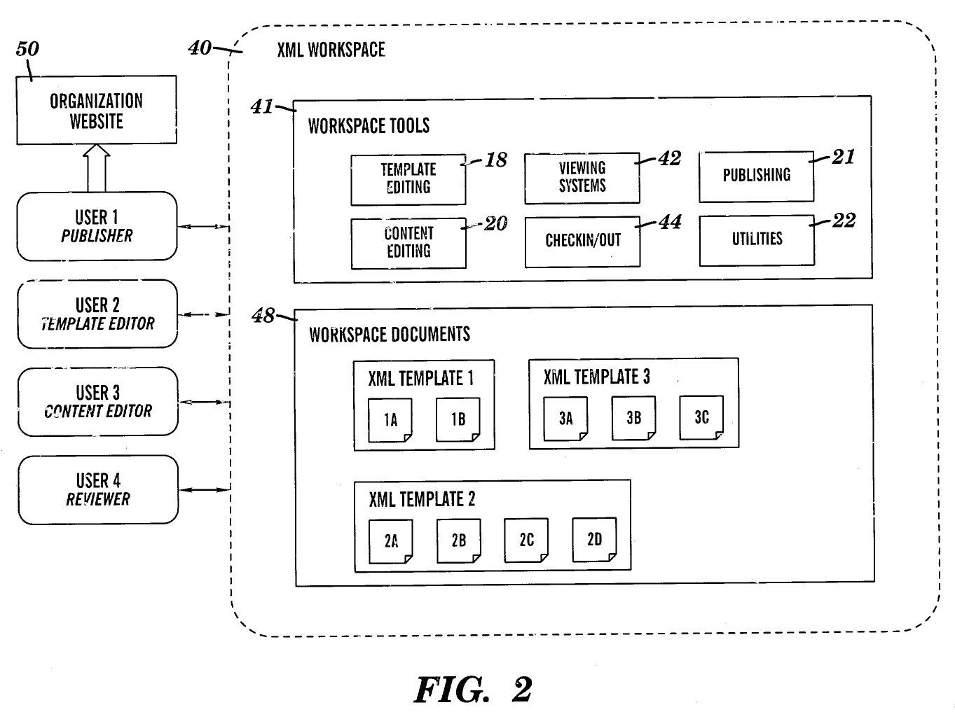

Referring now to FIG. 2, an exemplary XML workspace 40 is shown including workspace tools 41 and workspace documents 48. As can be seen, the workspace is accessible to a plurality of users (e.g., User 1-4) via the web. XML workspace 40 provides access to workspace tools 41 and workspace documents 48. Examples of workspace tools include utilities 22, and template editing and content editing systems 18 and 20 (described above). Additional examples include a viewing system 42 that provides different views of an XML document (e.g., XML source code, web page view, mobile device view, etc.) to facilitate the building of XML documents; a check-in/checkout system 44 for document control, as described above; and a publishing system 46 that allows XML documents to be easily published to an organizational website 50.

Workspace documents 48 comprise a plurality of templates organized as template folders (XML TEMPLATE 1, XML TEMPLATE 2, and XML TEMPLATE 3), each containing documents specific to the associated template. Thus, for instance, XML TEMPLATE 1 could comprise a “press release” template, and document 1A could comprise a first press release document announcing quarterly earnings, and document 1B could comprise a second press release document announcing a new product release. It is recognized however that the particular arrangement of XML templates within folders can be done in any manner.

As is further evident, each user has an associated permission or privilege level. For instance, User 1 has publisher privileges, thereby allowing User 1 to publish XML documents to the organizational website 50. User 2 has template-editing privileges, User 3 has content editing privileges, and User 4 has review only privileges. Privileges may be assigned at the workspace level, the template level, or the document level. It should also be recognized that a user might have multiple privileges (e.g., template and content editing).

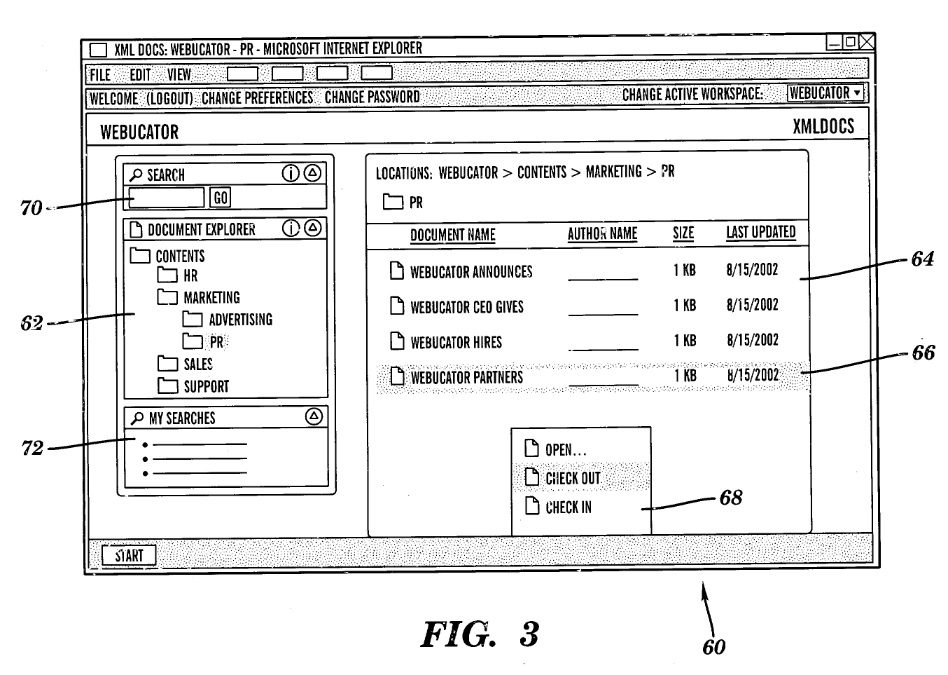

Referring now to FIG. 3, an exemplary XML workspace graphical user interface (GUI) 60 is depicted as delivered to a user via a browser (e.g., Microsoft's INTERNET EXPLORER™). GUI 60 includes a template window 62 for depicting folders for each template, organized in hierarchical fashion. A folder can contain documents created from any number of templates. For example, a marketing folder might contain press releases and product descriptions. In this case, the PR (for “press release”) folder is highlighted thereby signifying that a PR Content Browser window 64 is to be displayed. PR Content Browser 64 includes a list of XML documents in the PR folder. A highlighted XML document 66 indicates the document to be edited. A pop-up window 68 is provided that allows the document to be opened, checked out, checked in, published, copied, etc. Also included in GUI 60 are a search window 70, and a utilities window 72.

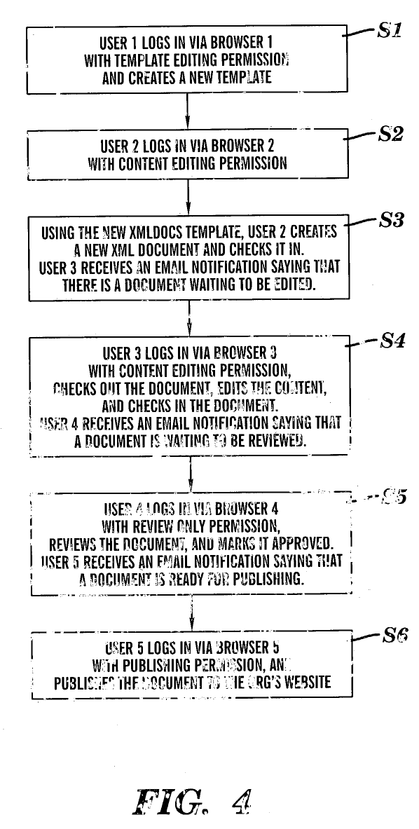

Referring now to FIG. 4, an example of a multi-user XML document processing workflow in accordance with the present invention is shown. In the first step S1, a first user (User 1) having template-editing permission logs into an organization workspace at the web server 10 via browser 1 and creates a new XML template. The template may be created from scratch or copied from another location, such as the public database 11.

Templates are made up of the following files:

1. An XML Schema or Document Type Definition (DTD) (required) for defining the structure of the XML documents.

2. A Cascading Style Sheet (optional) for describing the display of the XML documents in the editor.

3. A proprietary XML-based Hints file (optional) for enhancing the editing experience.

4. One or more XSLT(s) (optional) for displaying the published XML documents.

5. A proprietary XML-based Workflow document (optional—default Workflow used if omitted) for setting the workflow rules.

6. A template icon representing the template within the GUI (optional—default icon used if omitted).

The simplest XML template is made up of only an XML Schema or DTD and the default Workflow document and template icon. The additional files are optional and can be created using third-party editors or using the template editing system 18. In either case, creating templates generally requires at least some technical understanding of XML.

Next, at step S2, a second user (User 2) having content editing permission logs into the workspace. At step S3, User 2 creates content for the new XML template at the user's browser, and checks-in the newly created XML document (such that it is saved at the server). An email notification is sent to User 3 saying that there is a document waiting to be edited. Next, at step S4, a third user (User 3), also having content editing permission, logs into the workspace, checks out the XML document, re-edits the document, and checks-in the document. A fourth user, User 4, then receives an email notification saying that a document is waiting to be reviewed.

At step S5, User 4, having review only permission logs into the workspace, reviews the document, and marks it approved. An email is then sent to a fifth user (User 5) stating that the document is ready for publishing. Finally, at step S6, User 5, having publisher permission, publishes the XML document to the organization's website. Many other workflow scenarios are possible within the context of the present invention, and the above merely describes one typical example. Moreover, it should be recognized that the triggering of email notifications between and among users may be done automatically by the system, or manually by each user.

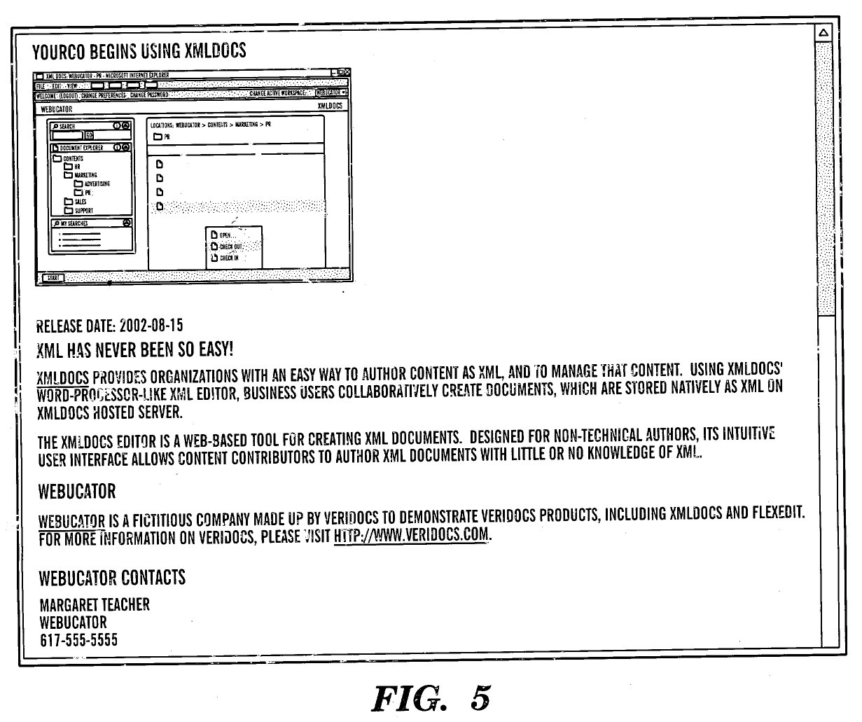

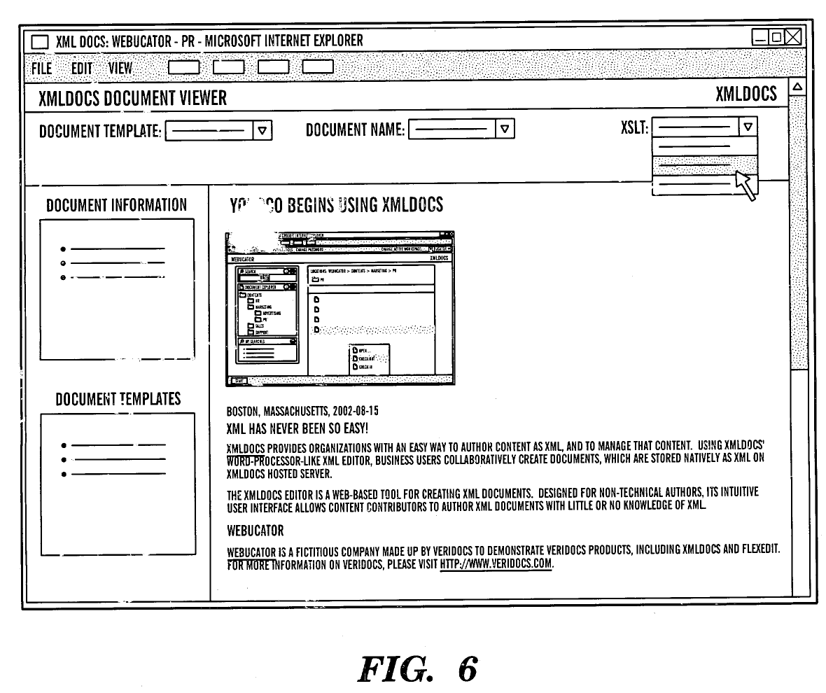

Referring now to FIG. 5, a content editing browser window is shown for editing an XML document within a press release template. As can be seen, the browser window provides a word-processor interface that uses standard word processing functionality. This editor is unique in that while it is downloaded and made available via a browser window 34 (FIG. 1), it is integrated with the web server 10 such that files are saved and managed at the server. FIG. 6 shows an exemplary document viewer that allows the user to, for example, view the XML document, view the XML scheme, or view the XSLT.

Referring now to FIGS. 7 and 8, the operation of publishing system 21 is described in further detail. As is known, after a set of XML documents are created, they need to be transformed before they can be loaded to a website (or elsewhere) in a human readable form. Each transformation usually involves three distinct documents, which become one.

1. The XML document (also referred to as an XML Instance). This contains the structured XML content;

2. An eXtensible Stylesheet (XSLT); and

3. A transforming process, which transforms the XML document according to the rules set in the XSLT. The process can be directed to save the result, display the result or both. Note that this process typically exists as a script that may make up a complete document, or comprise a single process within a larger document.

FIGS. 7 and 8 describe two embodiments for publishing XML documents 80 (e.g., Doc1, Doc2, Doc3) to a website 50. In both embodiments, a publishing system outputs a set (i.e., one or more) of documents in a compressed file 88. Compressed file 88 provides a convenient mechanism for transferring the relevant files from the remote web server 10 to the organization's website 50, and can utilize any known archive or compression system, e.g., a zip file. However, it should be recognized that the relevant files could be delivered individually, and/or uncompressed.

The creation and transfer of compressed file 88 can be initiated interactively from a user interface or programmatically using a web service. Programmatic access to the documents and XML templates may also be used to enable automated scheduled downloads and updates of content on the publisher's web server. Further web service functionality may include programmatic searching of a workspace for updated documents to optimize the number of documents downloaded.

In the first embodiment, shown in FIG. 7, the transforming process is implemented and controlled by the end-user at website 50. Thus, the “untransformed” XML documents 80 are packaged in compressed file 88 and are then downloaded to the website 50. The “untransformed” XML documents 80 are then transformed at website 50 using XSLT(s) 83 and a transforming process 85 provided by the end user. The result may for instance comprise an HTML index file 90 that provides links to each of transformed documents. This embodiment provides relatively more flexibility for the end user to control the display of the index file 90 and documents, but requires relatively more expertise in implementing XSLT(s) 83 and the transformation process 85.

In a second embodiment depicted in FIG. 8, a more simplified publishing system 21 is provided. Specifically, publishing system 21 automatically packages the XML documents 80 with related XSLT(s) 82 and a transforming process or script 84. Like the previous embodiment, these files are packaged in an archive or compressed file 88. In this embodiment, the publisher can uncompress compressed file 88 directly onto the organization's website 50 via the organization's web server. When the compressed file 88 is uncompressed, it produces an index file 90 (e.g., index.asp), which contains links to all the XML documents transformed against the appropriate XSLT(s). The publisher can transform their XML content in batch prior to a visitor viewing the page or dynamically during page viewing. Visitors to website 50 can then navigate to the index file 90 within a folder that was auto-generated by the publishing system 21. A mechanism on publishing system 21 can be provided to allow the publisher to specify the folder location.

The script that makes up the transforming process 84 is preferably made available in multiple languages (e.g., Active Server Pages, ColdFusion, Java, JavaServer Pages, ASP.NET, JavaScript, Perl, etc.). The appropriate language can be selected by the end-user (i.e., publisher) in, for instance, the workspace, via a dialog box, etc. The transforming process 84 can also generate one or more index files 90, which contain lists of links to the transformed documents. Users can create and/or supply their own XSLT(s) 82 to the publishing system 21 that describe the presentation of the index file 90 or the users can choose “canned” XSLT(s) 82.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for processing extensible markup language (XML) documents over the World Wide Web via a remote server, wherein the remote server comprises:
a workspace management system for creating unique workspaces for each of a plurality of organizations, wherein the workspace management system includes a document collaboration system for controlling access to XML documents;
an XML editing system for editing XML documents, comprising a template editing system for editing XML templates and a content editing system for editing XML content;
a database for remotely storing XML documents for the plurality of organizations; and
an application server for serving workspaces and the XML editing system to clients via the World Wide Web.

2. The system of claim 1, wherein the document collaboration system includes a check-in/check-out mechanism for accessing XML documents.

3. The system of claim 1, wherein the content editing system includes a word processor interface for editing XML documents within a client browser and for saving the edited XML documents in the database at the remote server.

4. The system of claim 1, wherein each workspace provides access to a set of XML templates and documents associated with an organization.

5. The system of claim 1, further comprising a publishing system for generating a set of files that allows an XML document to be published in a format selected from the group consisting of an hypertext mark-up language (HTML) web page format and a non-HTML format.

6. The system of claim 5, wherein the set of files includes an untransformed XML document, an extensible stylesheet (XSLT) and a transforming script that causes a transformed XML document to be generated with an index file that links to the transformed XML document.

7. The system of claim 6, wherein the XSLT is provided by an organization.

8. The system of claim 5, wherein the set of files includes an untransformed XML document that is transformed by an organization.

9. The system of claim 1, wherein the remote server further comprises a user administration system for logging users onto the remote server and linking users to permitted workspaces.

10. The system of claim 1, further comprising a database for storing public templates.

11. The system of claim 1, wherein the workspace provides access to a search facility for searching XML documents.

12. A web-based extensible markup language (XML) document processing system, comprising:
a system for remotely accessing a shared workspace from a web browser;
a system for remotely accessing and storing XML templates and XML documents from within the shared workspace;
a system for remotely editing and storing XML content from within a browser window; and
a system for controlling access to XML documents from within the shared workspace.

13. The web-based XML document editing system of claim 12, wherein the shared workspace and XML content editing system are served to the browser by an application server residing on a remote server on the World Wide Web.

14. The web-based XML document editing system of claim 13, wherein the remote server comprises a user administration system for logging users onto the remote server and linking users to permitted shared workspaces.

15. The web-based XML document editing system of claim 12, wherein the shared workspace is shared by a plurality of users within an organization.

16. The web-based XML document editing system of claim 12, wherein the shared workspace is shared by a plurality of users across a plurality of organizations.

17. The web-based XML document editing system of claim 13, wherein access to XML documents within a shared workspace is controlled with a check-in/check-out mechanism.

18. The web-based XML document editing system of claim 12, further comprising a publishing system that generates a set of files including an untransformed XML document, an extensible stylesheet (XSLT) and a transforming script that causes a transformed XML document to be generated with an index file that links to the transformed XML document.

19. The web-based XML document editing system of claim 12, wherein the shared workspace includes a mechanism for emailing members of the shared workspace.

20. The web-based XML document editing system of claim 12, wherein the shared workspace includes a search mechanism for searching XML content in the shared workspace.

21. A method of creating XML documents in a web-based shared workspace environment, comprising:
providing a server having: a workspace management system for creating a workspace for a plurality of users within an organization, an XML template editing system, an XML content editing system, and a database for remotely storing XML documents;
assigning permission levels to each of the plurality of users, wherein the permission levels include template editor and content editor;
logging a first user having template editor permission into the workspace via a first browser;
serving the XML template editing system to the first user and allowing the first user to create an XML template in the first browser;
storing the created XML template in the database such that it is available via the workspace;
logging a second user having content editor permission into the workspace via a second browser;
serving the content editing system in the second browser to the second user and allowing the second user to create an XML document using the XML template; and
storing the XML document in the database such that the XML document is available via the workspace.

22. The method of claim 21, wherein the XML document is accessed via a check-in/check-out mechanism.

23. The method of claim 21, wherein the permission levels further include a publisher, and wherein the publisher has permission to publish the XML document to an organizational website.

24. The method of claim 23, comprising the further step of publishing the XML document to the organizational website, including:
logging a third user having publisher permission into the workspace via a third browser;
selecting a publish option in the workspace;
generating a set of files having a set of XML documents, a set of extensible stylesheets (XSLT(s)), and a transforming script; and
loading the set of files onto an organizational website such that the transforming script generates an index file that includes links to the set of XML documents transformed against associated XSLT(s).
